(19) United States
(12) Patent Application Publication
(10) Pub. No.: US 2008/0147467 A1
(43) Pub. Date: Jun. 19, 2008

(54) Configuration Process Scheduling

(76) Inventor: Andreas W. Daum, Heidelberg (DE)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/563,004

(22) PCT Filed: Jun. 30, 2004
(86) PCT No.: PCT/EP04/51318

§ 371 Date: Dec. 6, 2007

(30) Foreign Application Priority Data
Jun. 30, 2003 (EP) 03014839.9

(51) Int. Cl. G06F 17/00

(52) U.S. Cl. 705/8; 705/7

(57) ABSTRACT

A method and system of configuring a business process for scheduling the business process comprising a plurality of activities, each activity comprising at least one of a start date type and a stop date type; the activities being in a time relationship to each other; wherein the business process is freely configurable with respect to the plurality of activities and with respect to the time relationships of the activities to each other.

The present invention relates to configurable process scheduling, and in particular to a method of configuring a business process for scheduling, and a method of scheduling a business process which is configured preferably by that method.

Furthermore, the invention relates to computer systems for performing the inventive methods, and to a computer-readable storage medium comprising program code for performing the inventive methods.

IT solutions of today for Supply Chain Execution have to be able to cope with business processes for the logistic fulfillment of orders, like purchase orders or sales orders. The fulfillment of orders is connected with the control and monitor of dates of specific activities within a business process. Some or all of these dates can either be given manually by data input of IT users, given via electronic data exchange by other business partners or have to be automatically determined by the IT system which is responsible for the fulfillment coordination of orders. In the latter case, a scheduling of the configurable business process has to be performed by the system by means of a program.

This scheduling has to cope with free configuration of business processes, the configuration of dates that are connected with a business process and the configuration on how the dates can be scheduled. These scheduling procedures have to be configurable in order to be able to schedule business processes that integrate several business applications, which take part in the business process, with one standard tool. Due to the fact that the date scheduling may not depend exclusively on pure time parameters like time zone, working hours and net lead times of activities, an open framework is needed for the determination of dates which allows for integration of complex date determination algorithms that may incorporate in-depth logic and master data of specific applications that are responsible for the business process part to which the date belongs to.

The scheduling has to comprise the ability of scheduling at different precision levels, for example a second, a minute or an hour. This scheduling precision has to be configurable per individual date of a business process in order to allow for a scheduling which can be adapted to the specific needs of an individual business process.

The scheduling has to handle time zones property, especially in case of rounding dates to certain time units like a day, in order to allow for scheduling business processes which incorporate business activities that are spread all across the globe.

These and other objects are achieved by methods and systems according to the independent claims. Further embodiments are defined in the dependant claims.

In general, in one aspect, the invention provides a method of configuring a business process for scheduling,
the business process comprising a plurality of activities, each activity comprising at least one of a start date type and a stop date type; the activities being in a time relationship to each other; wherein
the business process is freely configurable with respect to the plurality of activities and with respect to the time relationships of the activities to each other.

Advantageous implementations of the invention can include one or more of the following features.

A technical ID may be associated with an activity or with a date type.

A text may be associated with an activity or with a date type, the text being descriptive for the activity or for the date type.

Time units may be assigned to specific date types, the time units being freely configurable for each date type.

An activity can be modeled as a plurality of sub-processes.

A sub-process may comprise a plurality of activities.

A decision whether or not a delegation may be invoked is during run-time of the scheduling.

The service functions may be usable for determination of time zone, calendar and duration of an activity.

At least one service function may be assigned to at least one activity, the service function being usable, during scheduling, for determining start date and/or finish date of the at least one activity.

At least one delegation scheme is assigned to at least one activity, the delegation the service function being usable for invoking, during scheduling, an external application for determining start date and/or finish date of the at least one activity.

The activities and their time relationship may be representable as a network of nodes and edges, each node representing one of the pluralities of activities, and each edge connecting a pair of nodes and representing a predecessor-successor relationship of the activities represented by the respective pair of nodes.

A scheduling scheme may be produced based on the configured business process, whereby the scheduling scheme is a set of meta data descriptive of how the individual activities are to be processed within scheduling.

A scheduling scheme may be associated to the business process, the scheduling scheme comprising configuration data to at least one of duration, calendar, and time zone.

A scheduling scheme may be associated to the business process, the scheduling scheme comprising configuration data to at least one of service function, and delegation process model.

The invention also provides a business process configured with the method preferably according to the above method.

The invention further comprises a method of configuring a production process for simulating,
the production process comprising a plurality of steps, each step comprising at least one of a start date type and a stop date type; the steps being in a time relationship to each other; wherein
the production process is freely configurable with respect to the plurality of steps and with respect to the time relationships of the steps to each other.

Also provided by the invention is a computer system for performing the inventive methods, and furthermore, a computer-readable storage medium comprising program code for performing the inventive methods when loaded into a computer system.

A schedule tool, in the following referred to as “Configurable Process Scheduling” (CPS) is developed based on Advanced Business Application Programming Object-Oriented (ABAP-OO) technique. ABAP is provided by SAP AG. CPS comprises the ability to
define business processes consisting of activities relevant for scheduling. The business process modelling comprises the ability of top-down modelling, that is that a single activity may contain a sub-process. These sub-processes may be expanded during runtime of the CPS based on configuration settings;
define the technical ID and language dependant short text for the activities and the dates of the activities;
define the time units (like minute or hour) that shall be used for individual dates. Based on the given time unit, CPS performs a rounding in the frame of the local time zone of the activity,
setup of a scheduling scheme which is a meta-data framework that holds configuration data for several service functions performed within the CPS processing. These service functions are for example used for master data determination, like time zone, calendar and duration of an activity;
integrate other business applications by means of a delegation principle. CPS may delegate certain tasks to ABAP-OO classes, which may belong to other business components. This delegation principle can especially be used in the scheduling calculation itself when a pure generic scheduling, based on calendar, time zone and lead times is not sufficient. For example this is the case when a scheduled date has to be confirmed against capacities of resources within a complex planning application.

CPS provides a generic framework for scheduling pre-defined business processes in an environment of several business software components. CPS makes use of a process definition created by a business process modeler (BPM) and a set of meta data, the scheduling scheme, which is used to define the determination of several procedures that are performed within the scheduling. For example, the meta data of the scheme may define an access sequence to several services which may be used to provide master data needed for scheduling (duration, calendar, time zone).

The framework of CPS technically makes use of dynamic calls to ABAP-OO classes that implement certain interfaces defined by CPS. This technique is the same as the SAP Business Add-In (BADI) technique. The core framework of CPS does not contain those ABAP-OO classes that may be used within the definition of the scheduling scheme. The standard case will be that implementation of those classes and definition/shipping of schemes which make use of them has to be done by applications that make use of CPS (such as Fulfillment Coordination). Nevertheless, extensions of the core framework of CPS can be done in order to create ABAP-OO classes that are shipped by the package of CPS and can be used as elements of the definition of application-specific schemes. This may include classes that access a master data manager (MDM) or that access master data which is defined by means of CPS itself.

Given the fact that the development presented here is a generic framework, it may be used by several other applications in addition to Fulfillment Coordination. SAP development is able to deliver content within the scheduling framework (by delivering customizing data of CPS), which allows for scheduling application scenarios or business processes that are predefined by SAP Aktiengesellschaft, Walldorf, Germany. In addition, the CPS framework allows for custom specific changes of the framework content delivered by SAP and even allows for new custom specific definitions.

Configurable Process Scheduling is able to schedule a network of activities. The definition of this network consists of a description of a single activity and a description of the network.

A single activity consists of the following:
Activity type
Activity type category
Date type of the start of the activity
Date type of the end of the activity
Calendar and working hours of the activity
Time zone of the activity
Time unit of the start date, time unit of the duration and time unit of the end date

An activity network consists of:
Nodes (equivalent to a scheduling activity)
Lines (link predecessor and successor nodes)

Free configuration of the business processes, of the dates within a business process and of the date determination procedures are not possible with Transportation and Shipment Scheduling of SAP's Advanced Planer and Optimizer (APO). Transportation and Shipment Scheduling of SAP APO performs a scheduling based on a precision of a second only. It does not comprise the possibility to configure the usage of certain time units, like minute or hour.

The invention can be used for the scheduling of dates according to a given configuration of a business process, the dates of the business process and the scheduling procedures of these dates. The invention can be used for scheduling dates of applications that are technically installed on the same R/3 system as the scheduling configuration is situated. In addition, the invention can also be used as a remote scheduling tool by applications that run on different systems. The invention can also be used independently of any business application as a stand alone tool for scheduling dates. The latter one is made possible by a user interface (UI) of the invention which allows for scheduling dates according to data given via this UI, like the lead times of activities. This UI can be accessed by a WEB browser and thus may serve as an entry point for a WEB service that schedules dates of a business process.

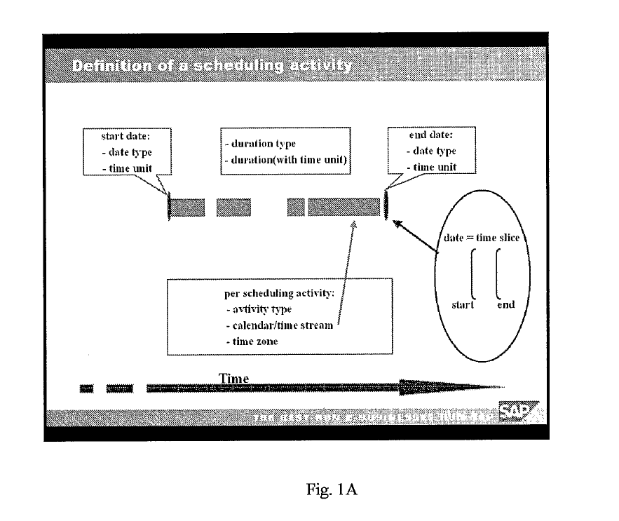

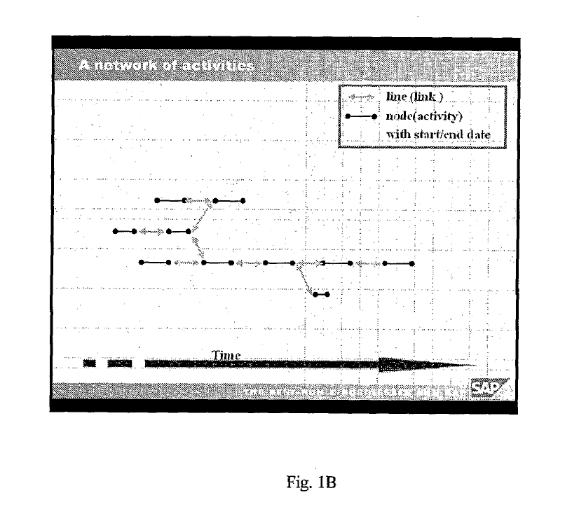

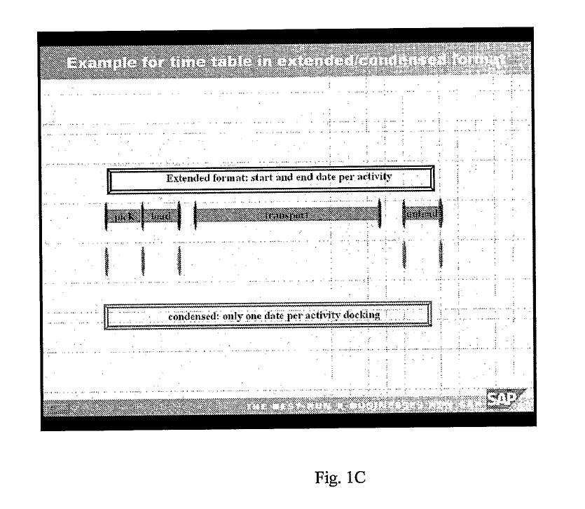

FIGS. 1A-C show the description of a scheduling activity and an activity network;

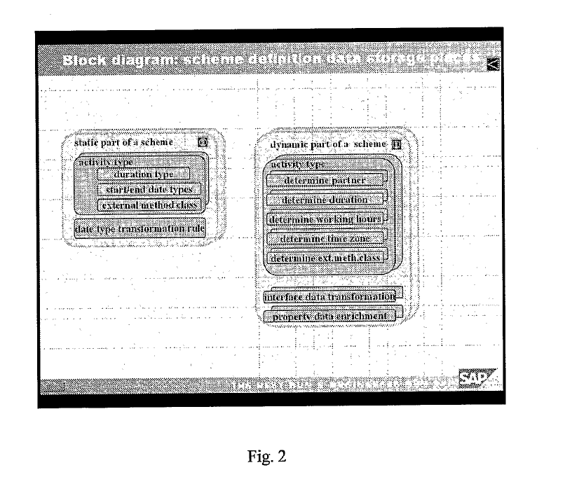

FIG. 2 shows in a block diagram an overview of the data storage places of the scheduling;

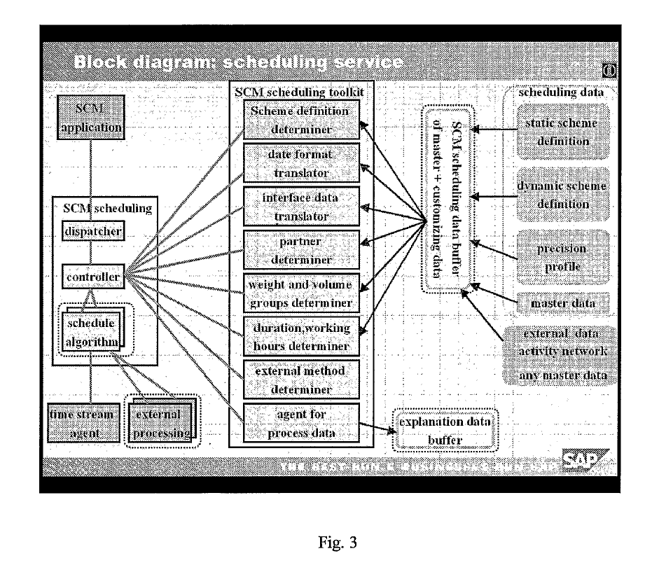

FIG. 3 shows, in a block diagram, an overview of the active components of the scheduling;

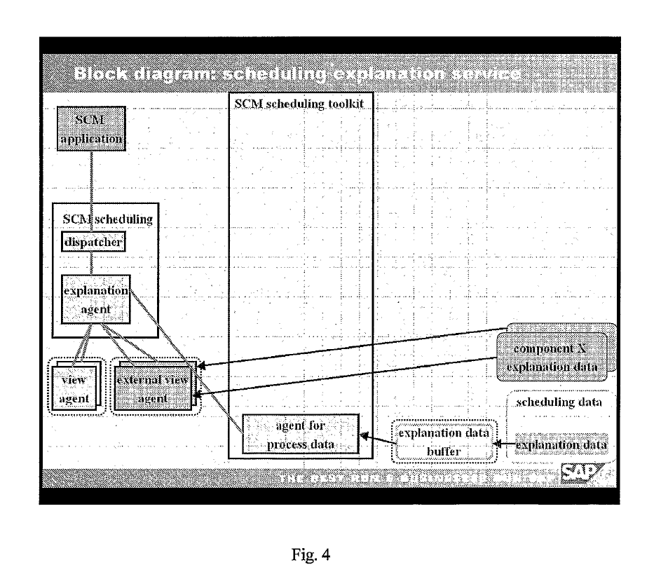

FIG. 4 shows, in a block diagram, an overview of active components of the scheduling when the explanation service is processed;

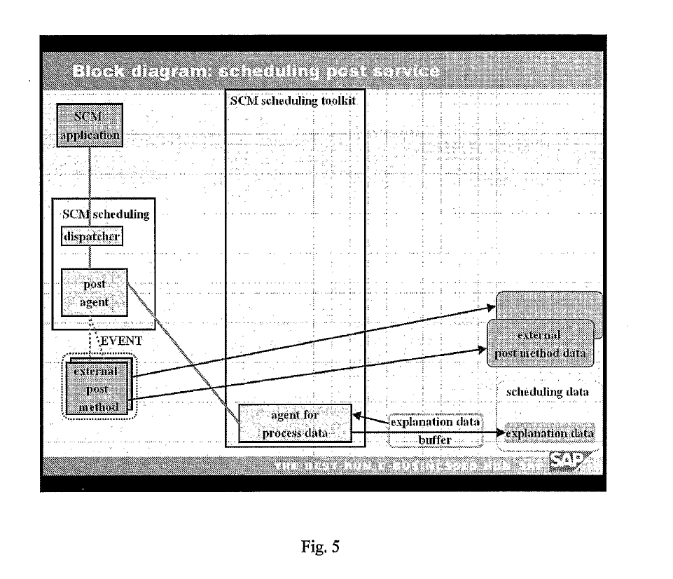

FIG. 5 shows, in a block diagram, an overview of active components of the scheduling when the post service is processed;

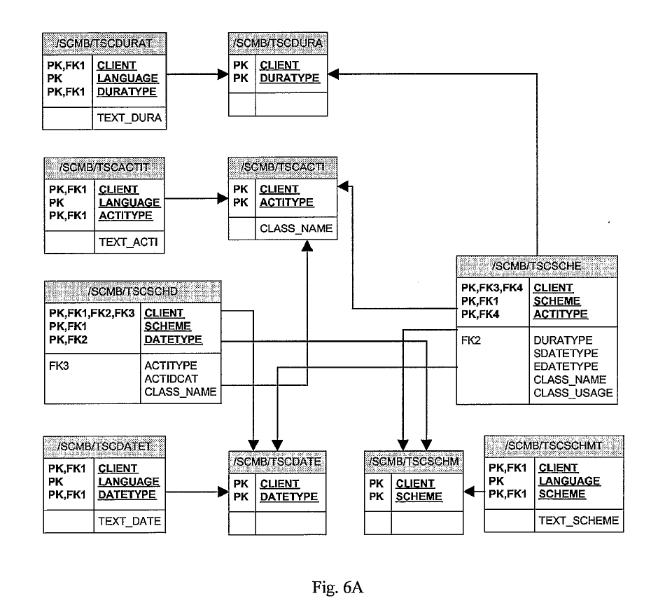

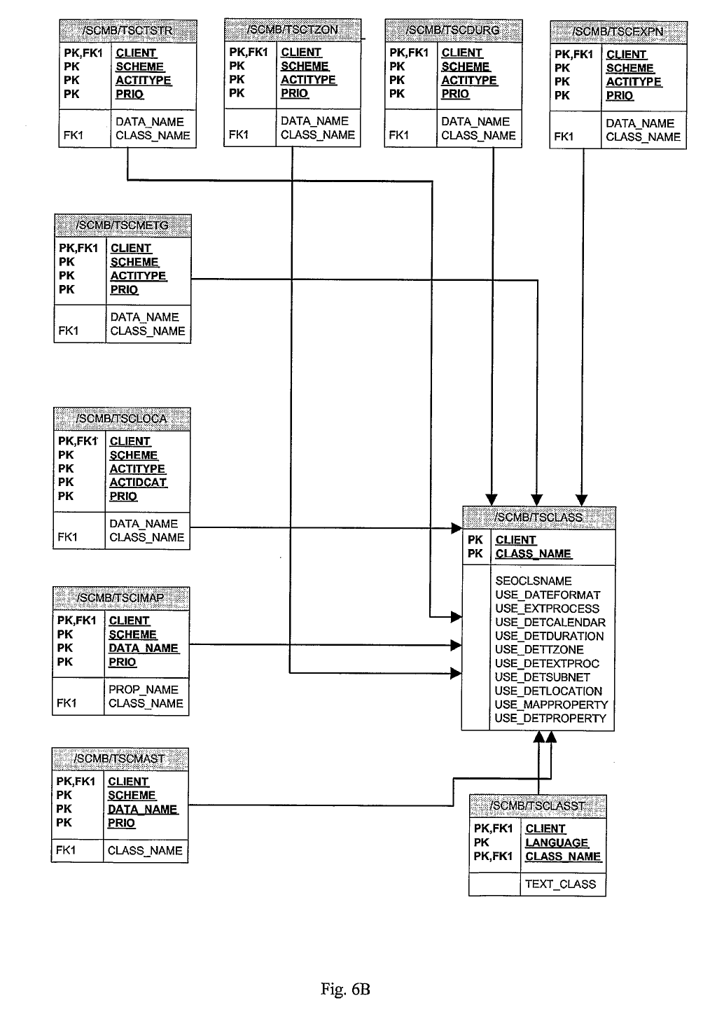

FIG. 6A shows the static part of the scheduling scheme;

FIG. 6B shows the dynamic part;

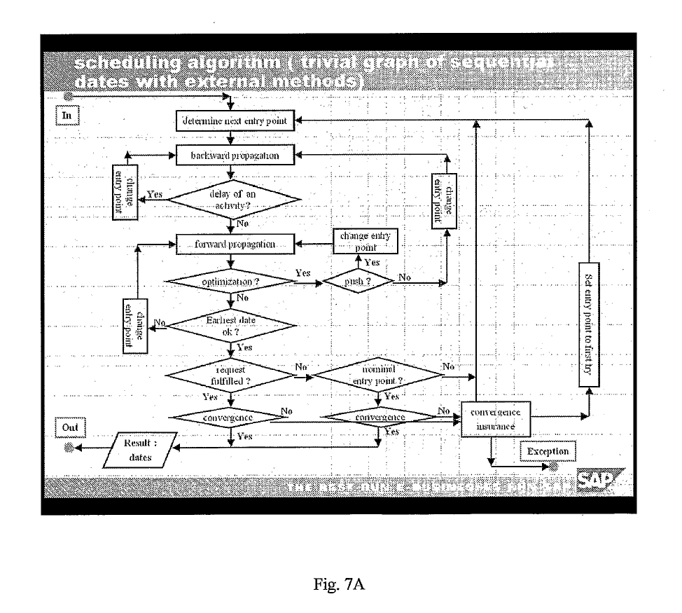

FIGS. 7A, 7B show flow charts of the scheduling algorithm according to the invention;

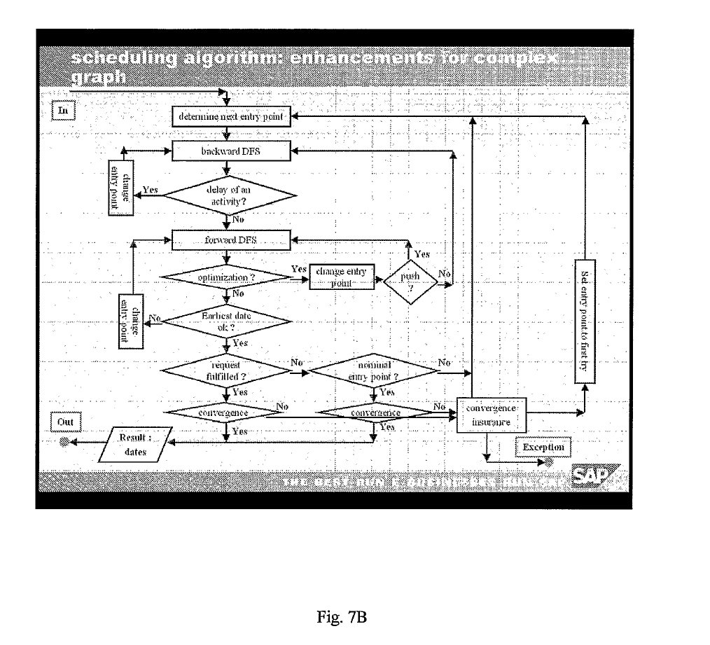

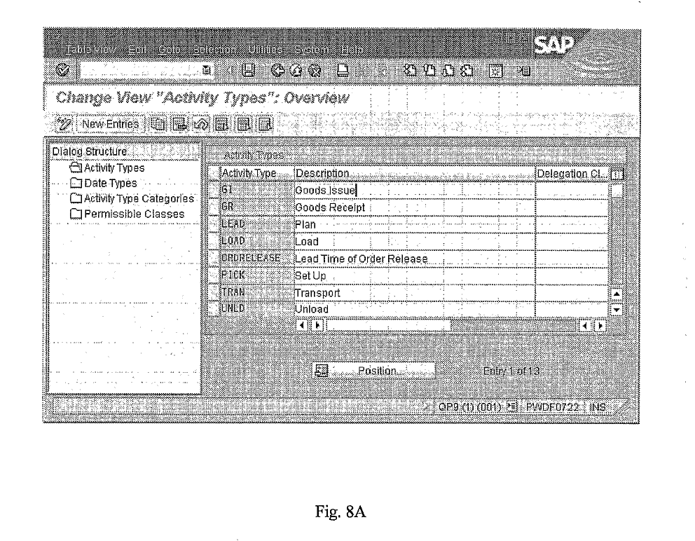

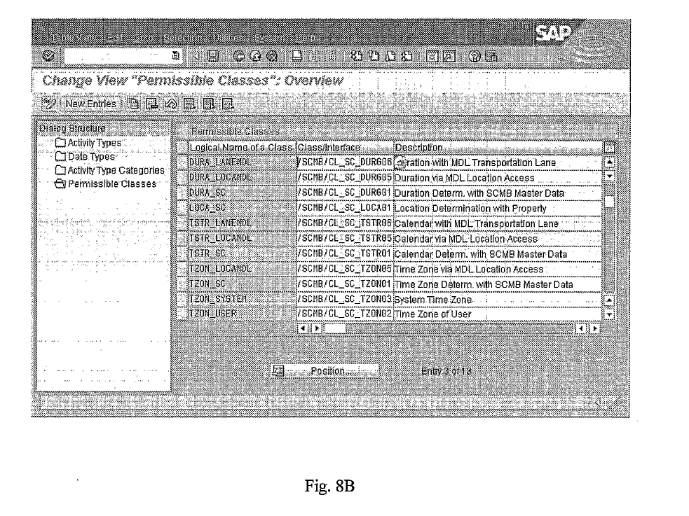

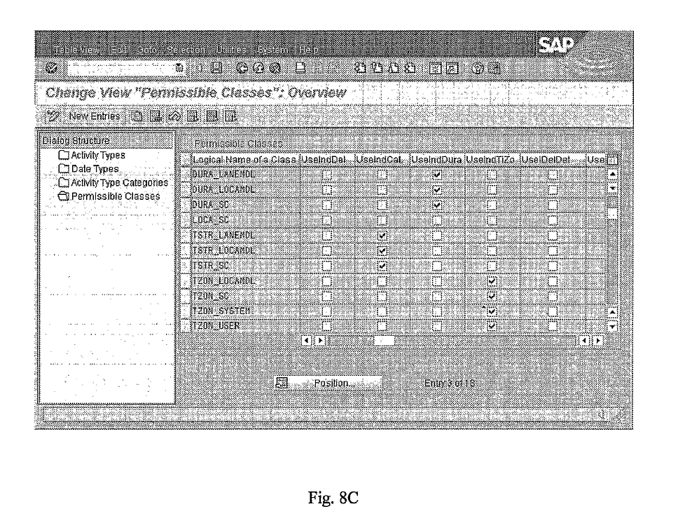

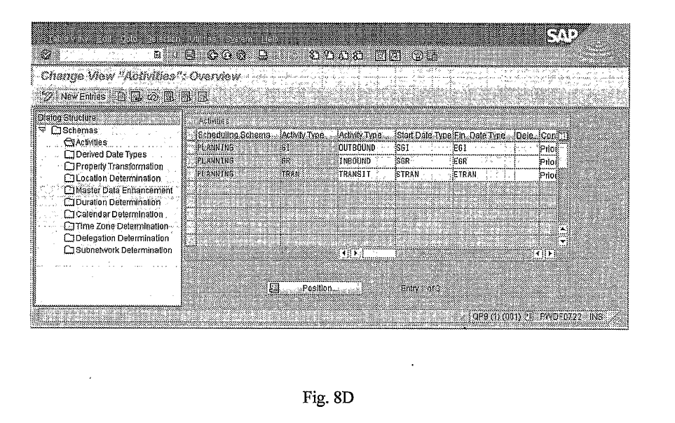

FIG. 8A-E give examples and screen shots of several user interfaces;

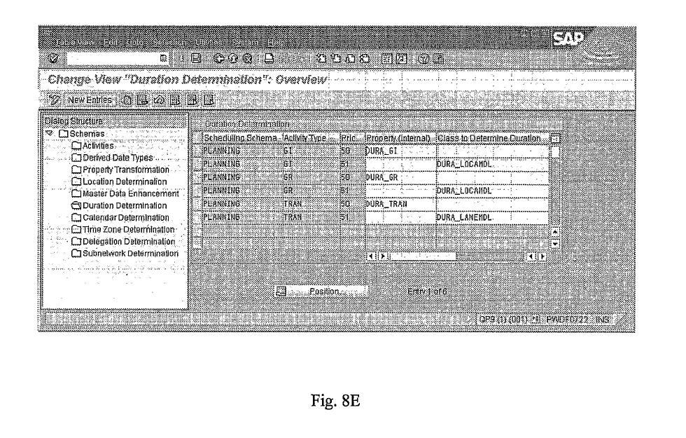

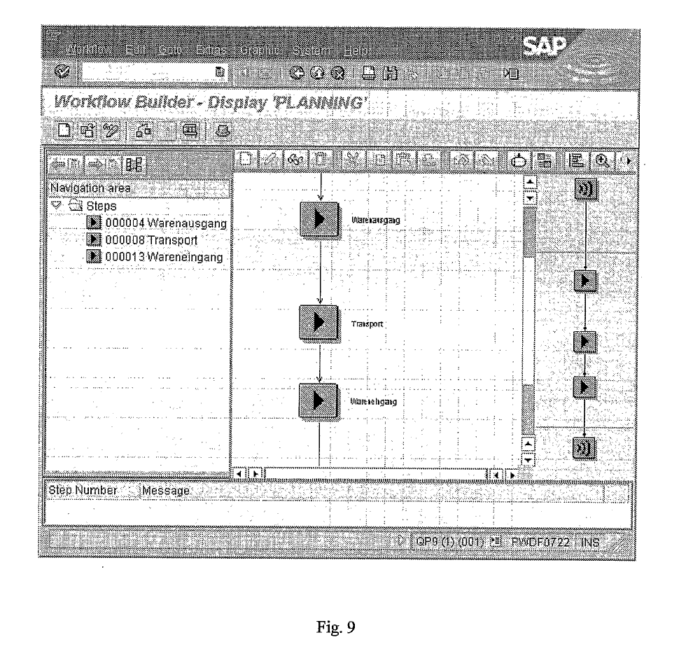

FIG. 9 shows the definition of the business process, which is used by ICH;

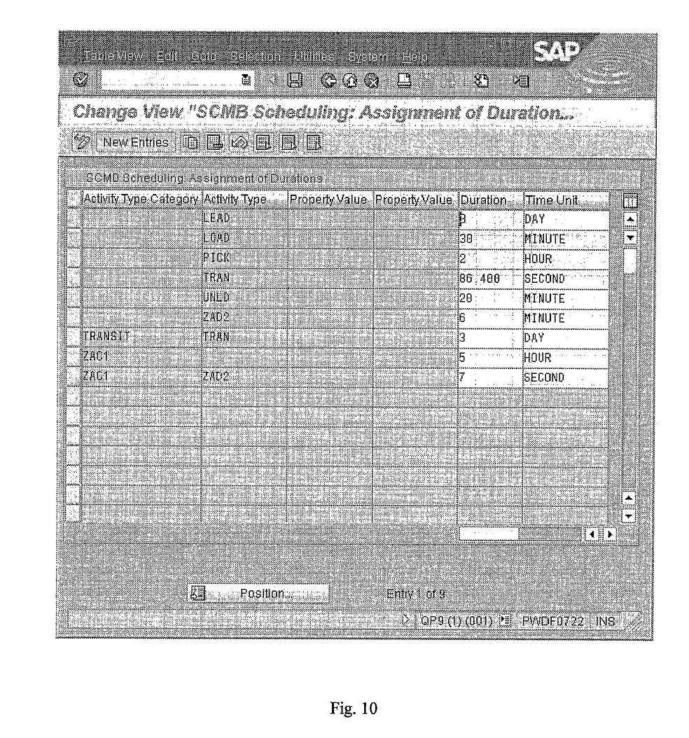

FIG. 10 shows the assignment of time durations to specific activities; and

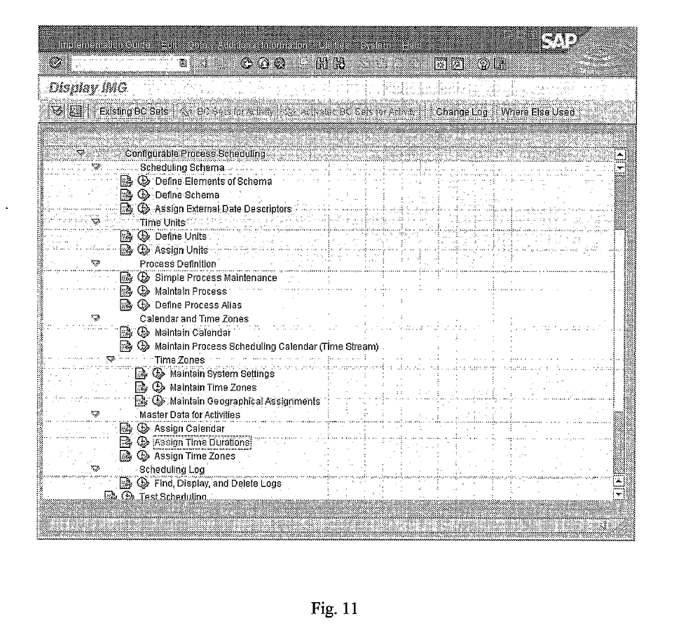

FIG. 11 shows the overview of the complete customizing of the configurable process scheduling;

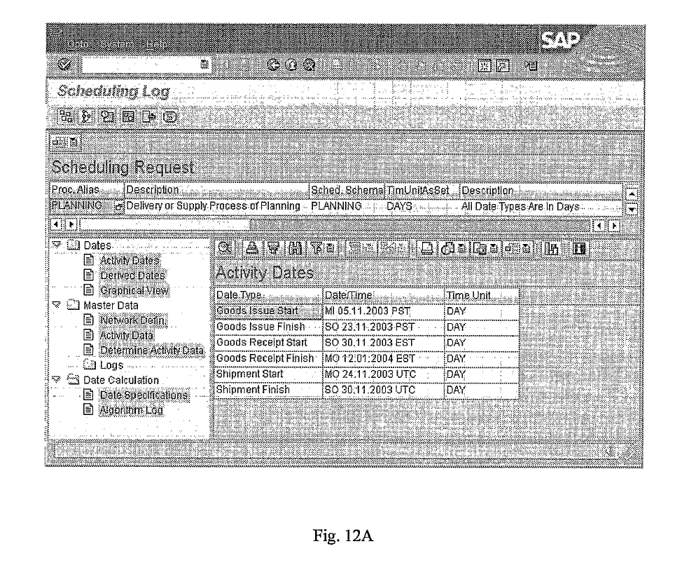

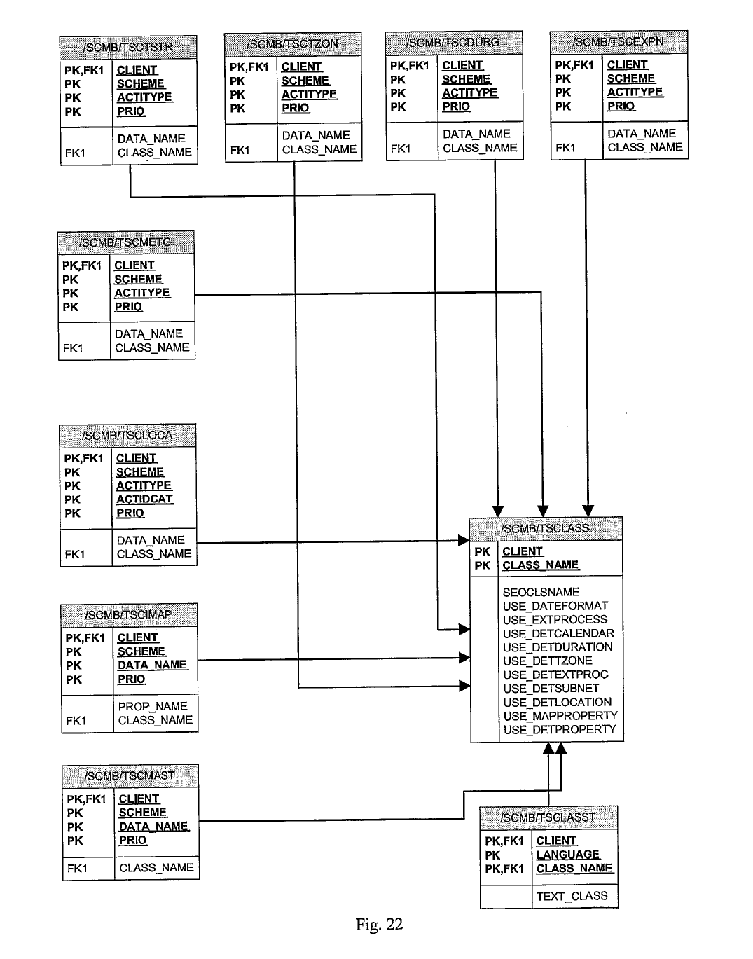

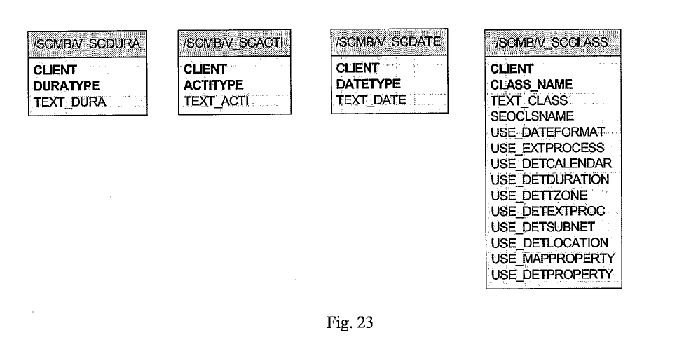

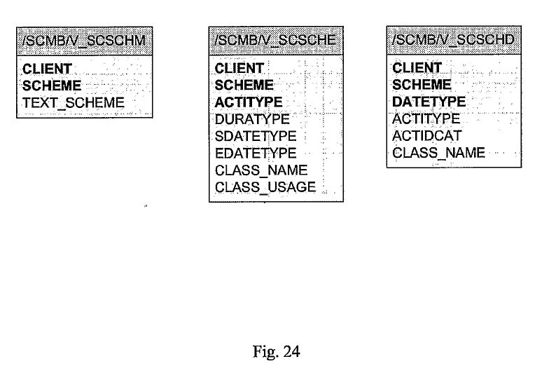

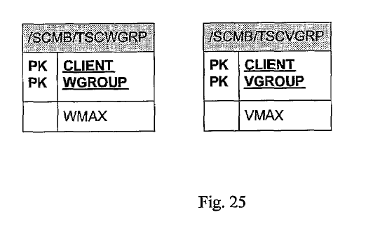

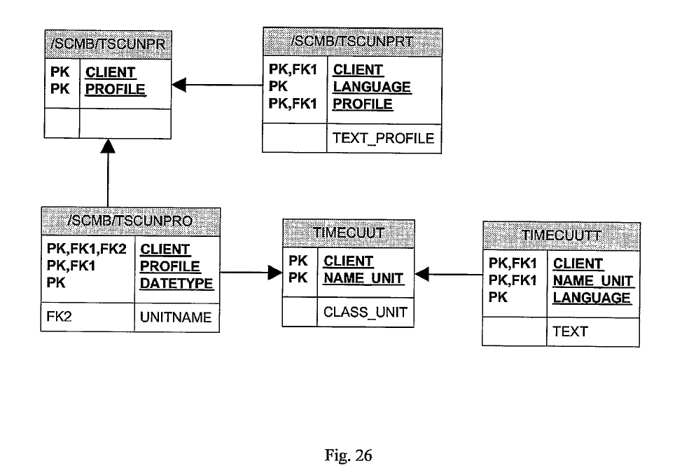

FIGS. 12-34 show further details of an embodiment of the invention.

FIGS. 1A, 1B show the description of a scheduling activity and an activity network, respectively. It should be noted that the activity type category is referred to as ‘duration type’ in FIG. 1A.

CPS can describe a network of activities in time by means of two different timetable formats. The complete timetable format consists of two dates for each activity (start and end-date of the activity). The derived timetable format consists of a list of dates that can be derived from the complete timetable. FIG. 1C shows an example of a simple activity graph with a complete and a derived timetable. It should be noted that in the Figures the complete and derived timetable are called extended and condensed timetable, respectively.

The scheduling comprises a data model to define the scheduling scheme, which is a set of meta data that describes a framework used for the technical processing of the scheduling. In addition to the scheme definition managed by CPS an activity network definition has to be maintained using SAP WEBFLOW builder as a business process modeler (BPM). Thus, the activity network definition is managed by the SAP WEBFLOW data model.

CPS comprises a data model of a Process Scheduling Calendar, which is the definition of working hours with a precision of a second. In addition, public holiday and factory calendars of SAP Basis, which describe the working periods with a precision of a day, can be used within CPS. CPS comprises also the possibility to make use of time zones and time units, like minute or hour, which can be defined and maintained by means of SAP Basis. CPS includes a data model of the so-called ‘time unit assignment set’, which assigns an individual time unit to each date of a list of dates. Thus the same business process may be scheduled with different precisions by means of using different time unit assignment sets.

CPS comprises a data model for assigning calendar, time duration and time zone to the activities of a scheduling scheme. This enables for usage of the CPS without any other source of scheduling master data. Thus, CPS may be used as a self-contained scheduling tool. In addition to this CPS master data assignment, classes that are set up in the dynamic part of the scheme (and that implement the interfaces specified by CPS) may use any additional master data available to the business software components to which these implementation classes belong.

In addition to the customizing data of the scheduling framework and the scheduling master data, CPS has to manage transactional data. This includes the data that is needed for the explanation service of CPS. This explanation data consists of a data buffer (an object in the memory) and persistent data (by means of database tables). An explanation of previously processed scheduling calls is thus made possible within a transactional context and also offline (without the transactional context in which the scheduling call was processed).

FIG. 2 shows in a block diagram an overview of the data storage places of the scheduling.

CPS comprises services for the following:
Scheduling of a business process. The scheduling service has the ability to schedule multiple independent scheduling requests in a single service call.
Presenting and explaining the scheduling result.
Posting scheduling transaction data and data of delegation processing.

These services are implemented as methods of a global ABAP-OO class, which may be used by any application that is situated on the same system as the scheduling framework. In addition, the services are implemented as remote enabled function modules (in accordance to the SAP BAPI standards), which might be used by any remote SAP application.

Note that the block diagrams in the following sections are in accordance with the graphic and syntax standards as described in SAPNet. The wording used in the text is also agrees with this syntax. Do not misunderstand the word ‘agent’. An ‘agent’ in this context is a piece of a functional program, such as an ABAP-OO class method or a function module, in contrast to other types of building blocks such as data storage places.

FIG. 3 shows, in a block diagram, an overview of the active components of the scheduling when the scheduling service is processed. Please note, that in the Figure, CPS is called ‘SCM scheduling’.

An external application calls the scheduling service via its application interface (API). The CPS (‘SCM scheduling’) first routes all methods of the API through an entry agent which then carries out a functional dispatch. This entry agent provides a single point of entry to the CPS framework internally, although the framework provides several API methods.

If scheduling is requested, the entry agent will dispatch to the scheduling controller. The controller first performs a pre-step that makes use of the scheduling toolkit in order to derive the static scheme and the dynamic scheme. This results in a description of the complete graph of activities that includes information from the scheduling scheme, the activity network and the master data. This graph of activities description holds all information necessary for a subsequent scheduling engine. The controller then invokes the scheduling engine.

The scheduling engine performs the pure scheduling algorithm for a network of activities.

Scheduling of individual activities is done by the activity objects that are instances of an ABAP-OO class. Activity objects are contained in the description of the graph of activities built by the controller. They make use of an interface of a time stream agent that is able to carry out basic scheduling functions by means of SAP Basis package SZTI. Package SZTI provides the functions needed to calculate with different time units taking time zones, factory calendars and time streams into consideration. Activity objects also make use of an interface for external processing, the so-called delegation, which might have to be called for certain activities in order to set start- or end-date of the activity, or in order to schedule the complete activity using an external method.

After the scheduling engine has completed its work, the controller stores the result and additional explanation data in the explanation data buffer.

FIG. 4 shows, in a block diagram, an overview of active components of the scheduling when the explanation service is processed: Please note, that in the again, CPS is called ‘SCM scheduling’.

An external application calls the scheduling service via its API. CPS (‘SCM scheduling’) first routes all methods of the API through an entry agent which then carries out a functional dispatch. If an explanation is requested, the entry agent dispatcher will call the explanation agent.

The explanation agent first retrieves data of a preceding scheduling service call (which may still be stored in the transient explanation data buffer or which is available via persistent database storage) and then provides several views. The explanation agent contains a view controller in order to manage the different views. Views to explain the results of delegation (‘external processing’) can also be provided.

FIG. 5 shows, in a block diagram, an overview of active components of the scheduling when the post service is processed. Please note, that in the figure CPS is called ‘SCM scheduling’. An external application calls the scheduling service via its API. CPS (‘SCM scheduling’) first routes all methods of the API through an entry agent which then carries out a functional dispatch.

If a post is requested, the entry agent dispatcher will call the post agent. The post agent may retrieve the transient explanation data buffer and post this data to the database.

The post agent will raise a public event ‘POST’ of ABAP-OO class /SCMB/CL_SC_CONT. This enables all instances of classes that were previously used for delegation (‘external processing’) to execute their specific postings (data saving). These classes will not be destroyed when the scheduling method is carried out if they subscribe to this event. Thus CPS comprises a transactional concept, which ensures consistent data postings across several business applications which might take part in the scheduling (via the delegation principle).

A scheduling scheme is a set of meta-data that describes a framework that is used for the technical processing of the scheduling. It is a definition on how to handle individual activities of business processes within the scheduling and it is a definition on how to determine the master data needed for scheduling, such as duration and calendar of an activity.

The data model of the scheduling scheme consists of the definition of ‘atomic’ objects (which are the components of a scheme) and the definition of the scheme itself. ‘Atomic objects’ may be reused in several different schemes. ‘Atomic objects’ are:
Activity type (like ‘Load at issuing plant’ or ‘Load ship at harbor’, for example): Defines the activities that can be used to define scheduling schemes. For each activity an ABAP-OO class can be maintained as default at the activity level for external processing. Activity types are defined by tables /SCMB/TSCACTI and /SCMB/TSCACTIT (see FIGS. 6A, B).
Activity type category (like ‘loading’, ‘packing’, ‘picking’): Several activities of a scheduling scheme may use the same duration type. For example ‘loading’ might be used for an activity at the issuing plant but may be used in addition for an activity at a load transfer point (at a harbor . . . ). Based on the activity type category conditions/rules for determination of the duration of an activity may be setup. Activity type categories are defined by tables /SCMB/TSCDURA and /SCMB/TSCDURAT (see FIGS. 6A, B).
Date type (like ‘delivery date’, ‘material availability date’): Date types are used to describe the start and end dates of an activity. This is the so-called complete timetable format. Date types may also be used to define the derived timetable format. The derived format contains a subset of all start/end dates of activities of the process. A date type may be used for the complete and for the derived timetable format at the same time. The date type does not carry a category that differentiates between the complete/derived time table formats. Date types are defined by tables /SCMB/TSCDATE and /SCMB/TSCDATET (see FIGS. 6A, B).

Each of the ‘atomic objects’ has a technical name and a language-dependent text that can be used for a UI presentation.

A scheduling scheme comprises a list of activity types for which the framework definition has been set up. Only activity types that belong to the same scheme can be used in the definition of a business process (one process definition of the BPM can refer to a single scheme only). A scheme definition can be reused in several different business process definitions, with the restriction, that the business processes use only those activity types that belong to the scheme.

Scheduling schemes have to be pre-defined during a setup phase when the business processes, that is, activity network, are defined. Applications that make use of the scheduling service in order to schedule individual business processes pass the key of the activity network definition (that is, workflow-ID or a process alias name that is connected to the workflow-ID via a mapping available in the CPS customizing) to the scheduling. This activity network defines which activities are present in the business process and how they are related in time. In addition, the activity network definition contains a reference to the scheme that will be used in the scheduling.

The ‘atomic objects’ and the scheme will have a protected SAP namespace by using table TRESC. This allows the delivery of standard business scenarios by delivering table datasets that describe standard atomic objects and standard schemes. Note that the namespace definition of table TRESC is the major reason for the existence of the symbolic names for ABAP-OO classes that will be used in the CPS framework.

A scheduling scheme consists of a static part of the scheme and a dynamic part of a scheme. FIG. 6A shows the static part of the scheduling scheme, while FIG. 6B shows the dynamic part.

Definition of the static part of scheme (see FIG. 6A):
Table /SCMB/TSCSCHM defines the scheme identifiers.
Table /SCMB/TSCSCHMT provides a language-dependent description text for each scheme identifier.
A scheme consists of a list of activity types (see table /SCMB/TSCSCHE)
For each activity type of a scheme the activity type category, date type of start and end of the activity has to be defined. This is done by the fields DURATYPE, SDATETYPE and EDATETYPE of table /SCMB/TSCSCHF. Note the restriction that the date types used for start/end of the activities have to be unique within a scheme. This allows for unambiguous transformation between date types and start/end-points of activities. The uniqueness of the date types will be guaranteed by the secondary indexes of table /SCMB/TSCSCHE and by checking the input data in the view maintenance.
For each activity of a scheme an ABAP-OO class for external processing can be set as default at the level scheme/activity (field CLASS_NAME in table /SCMB/TSCSCHE). The ABAP-OO class is set by a symbolic name CLASS_NAME. The symbolic names CLASS_NAME are defined in the dynamic part of the scheme using table /SCMB/TSCCLASS.

For each activity of a scheme a control parameter that enables for delegation (‘external processing’) can be maintained (field CLASS_USAGE of table /SCMB/TSCSCHE). This parameter can have the values: No external method class use, always take default from activity definition, always take default from definition of static scheme, always take dynamic determination depending on application data, evaluation by priority: Dynamic determination, static scheme definition, activity definition
For each activity of a scheme the start and end can be mapped to a date type that is used for the derived timetable format. This mapping is done using table /SCMB/TSCSCHD. Field DATETYPE denotes a date type of the derived timetable format. ACTITYPE denotes an activity type of the scheme and ACTIDCAT denotes whether the start or end of the activity should be mapped (ACTIDCAT may have the values A=‘start of activities’, B=‘end of activity’).

The dynamic part of a scheme (see FIG. 6B) defines the behaviour of the scheduling for a certain scheme depending on application data that is passed to the scheduling service call. The definition of the dynamic part comprises:
A definition for ABAP-OO classes (via table /SCMB/TSCCLASS) that can be used in the scheme definition. This definition indicates for which purpose the class may be used. This is indicated by the fields USE_* which are simple flags. The definition is done by first defining a symbolic name for an ABAP-OO class (field CLASS_NAME) and by linking an ABAP-OO class to this symbolic name (field SEOCLSNAME). It is thus possible to ship the datasets of table /SCMB/TSCCLASS as predefined SAP customizing content (like for all other CPS customizing tables). In addition, using table /SCMB/TSCCLASST, a text describing the functional role of the class can be defined for each symbolic class name.
A definition of the transformation of externally provided properties (passed to the scheduling via an interface) into the internally used table of properties. This is done using table /SCMB/TSCIMAP that might have several datasets for an internal property DATA_NAME. Mapping might be carried out directly by passing the value of a property PROP_NAME (provided by the calling application via the interface of the scheduling) or it might be performed in a more complex way using an ABAP-OO class that implements the mapping interface /SCMB/IF_SC_IMAP. In addition to the mapping, all properties that are passed via CPS interface are transferred with a name identical to an internally used property. This is only true for those externally provided property names that are not used as DATA_NAME in table /SCMB/TSCIMAP. The internally used table of properties is the starting point for the determination procedures described below.
A definition of location/business partner determination. This is done using table /SCMB/TSCLOCA. For each start/end date of an activity of a scheme a location/partner may be determined directly by value mapping from an internal property DATA_NAME or by using an ABAP-OO class that implements interface /SCMB/IF_SC_LOCA. These locations/partner IDs may subsequently be used to determine the duration, working hours and time zone of the activity. Within the scheduling framework several different types of business partners/locations may be used. For example one may make use of the ABA business partner with ABAP data element BU_PARTNER (CHAR10) or the APO location with ABAP data element /SAPAPO/LOCID (CHAR22). Inside the scheduling framework the partner will be treated in a generic manner as a property of the activity. Applications that make use of CPS are responsible for the consistency of the partner determination setup and the procedures setup (see below) that may make use of these partner IDs. The procedures that use the partner IDs have to be adapted to the type of partner.
A definition of enrichment of internally used property data. This is done using table /SCMB/TSCMAST. For each scheme a set of internal property names (field DATA_NAME) can be defined. For each property name several ABAP-OO classes, which implement interface /SCMB/IF_SC_MAST, can be specified with different priorities. In case the property is not yet known in the scheduling (because it could not be determined by transformation from the properties provided via the scheduling interface), CPS will use the ABAP-OO classes in order to determine the property. This is the how master data or application-specific data might be read during Configurable Process Scheduling. Access to the data is not performed in the core coding of the CPS framework but is done within the dynamically chosen ABAP-OO classes. These implementation classes may belong to a package/software component different to CPS.
A definition of the working hour (time stream) determination. This is done using table /SCMB/TSCTSTR. For each activity of a scheme the time stream id might be determined by directly passing the value of an internal property or it might be determined by means of an ABAP-OO class that implements interface /SCMB/IF_SC_TSTR. In order to schedule with the time unit ‘day’ in addition to a time stream, a factory calendar may be determined by means of the ABAP-OO class. It is no be noted that the basic scheduling algorithm decides on the basis of the given time unit of the activity duration whether a SAP time stream, a SAP factory calendar or no work time description is used. For time units below a day, always the time stream is used which may describe working hours with a precision of a second. In case of an activity duration time unit of a day, a SAP factory calendar is used. In case of duration time units greater than a day, like a week or a month, no work time description is used. The value of a property may consist of a time stream ID concatenated by a factory calendar ID. A factory calendar can also be determined by means of a property. For an activity of a scheme several datasets of table /SCMB/TSCTSTR might exist with different priorities.
A definition of duration determination. This is done using table /SCMB/TSCDURG and is analogous to time stream determination. Note that duration consists of a value and a unit. The value of the internal property that is used for duration determination has to consist of a value concatenated with a unit.
A definition of time zone determination of activities. This is done using table /SCMB/TSCTZON and analogous to time stream determination. The time zone of activities is needed to round dates and to schedule in case a factory calendar is used. Note that each activity has a single time zone. The time zones used in the scheduling algorithm to round start and end dates are identical to the time zone used to schedule the duration with regards to a calendar. If an application wants to make use of different time zones, it has to model an activity network consisting of several activities. For example a transport from Germany to US-East that will include the two different time zones has to be modeled by three activities: Goods issue, transport and goods receipt. Goods issue and goods receipt will have the time zones CET and EST, whereas the transport activity will have the time zone that corresponds to the working calendar of the ship.
A definition of the determination of ABAP-OO classes for delegation (also called ‘external processing’). This is done by table /SCMB/TSCMETG and is analogous to time stream determination. This determination may take place depending on the CLASS_USAGE field of table /SCMB/TSCSCHE.
A definition on how to evaluate if sub-networks, which are attached to an activity, will be expanded in the scheduling. This is done by table /SCMB/TSCEXPN.

With the definition of the activity network a business process is defined from point of view of the scheduling. The activity network defines the set of activities present in a business process as well as their relation in time. The network definition has to include a cross-reference to a scheduling scheme that will be used during the scheduling of the activity net.

The network definition is carried out by means of the SAP WEBFLOW (SAP workflow). Configurable Process Scheduling reads the data stored within SAP WEBFLOW. In the SAP WEBFLOW business process modeler (BPM) in the basic data section, which is the data at header level of a workflow, a property that denotes the key of a scheme has to be defined. The name of the property will be a fixed name ‘SAP.SCM.BAS.SCH.SCHEME’. With this property the scheme that will be used in the scheduling of the process is denoted.

In the step maintenance of the BPM, you can define that a property that denotes the technical name of the business process step is a scheduling activity. The name of the property will be a fixed name ‘SAP.SCM.BAS.SCH.ACTITYPE’. If this property is present for a workflow step, this step is relevant for scheduling. If this property is not present for a workflow step the step is not relevant for scheduling. The value of the property denotes the activity type of the workflow step.

A network of scheduling activities can be derived from the workflow network of steps. This network of scheduling activities may not contain all workflow steps due to neglecting steps that are irrelevant to scheduling. The set of links between scheduling activities of the network of scheduling activities is derived from the links of the workflow network of steps. Workflow lines that end at a step irrelevant to scheduling are concatenated. These concatenated lines are the lines of the activity network that have a step relevant to scheduling at both ends of the line.

The BPM of SAP workflow allows for top-down modelling of a business process those results in steps that contain a sub-network (sub flow). The header property ‘ . . . SCHEME’ of sub-networks has to be identical to the scheme used for the overall network definition (parent workflow). Configurable Process Scheduling will be able to expand these sub-networks in order to obtain the complete activity network. Steps that contain sub-networks do not need to have the property ‘ . . . ACTITYPE’. In the latter case, these steps themselves will never be part of the scheduling network (but their sub-network will be part of the scheduling network).

If the activity network definition contains process steps that are sub-networks, two different types of process steps have to be handled differently in the scheduling:
1) A process step contains a sub-network and has the property ‘ . . . ACTITYPE’. In this case two possibilities exist:
   a) Expanding the sub-network during scheduling
   b) Do not expand the sub-network but take the parent step as a single scheduling activity as an estimate of the sub-network instead
2) A step that contains a sub-network does not have the property ‘ . . . ACTITYPE’. In this case the sub-network always has to be expanded in the scheduling since no representation of this part of the process would be there in the scheduling otherwise.

During the scheduling of a network, a decision has to be made for steps of type 1) whether the sub-network should be expanded or not. This will be done according to the settings of table /SCMB/TSCEXPN in the same way as the other tables of the dynamic part of the scheme (like table /SCMB/TSCMETG or /SCMB/TSCTSTR). Thus the expansion of individual activities can be controlled by several different procedures (via interface data and via different ABAP-OO class implementations of an interface) with different priorities. For example, you may set up a dataset in table /SCMB/TSCEXPN for each activity with DATA_NAME=‘ACTITYPE_EXPAND’ where ACTITYPE is the name of the activity as given in the BPM step which holds the sub-network. Using interface data (table of properties) of the scheduling, the calling application may then control the expansion of certain sub-networks by submitting the relevant property ‘ACTITYPE_EXPAND’ with value ‘TRUE’.

Zooming into the details of a business process and thus scheduling it by taking into account more details may be used to have different views of a business process. This could be depending on the current process step where the business process is. You might have different levels of zoom for a preview of a business process, and during the different stages when the process is partially evolved.

Delegation (‘external processing’) is possible not only for single activities but for a sub-network that comprises several activities contained in the overall network. This will be possible for activities that are directly linked together, that perform 2^{nd} grade external processing (that is, the complete activity is determined by delegation) and all activities make use of the same ABAP-OO implementation class for delegation.

Because these ABAP-OO classes may be determined dynamically during runtime, a static definition of the sub-networks that can be processed coherently (together) is not possible. The determination of sub-networks for coherent external processing is done during runtime according to the criteria given above.

The determination of sub-networks for coherent external processing is done in the pre-step of the controller. Thus the schedule algorithm makes use of the network definition and does not perform any network determinations itself. The overall architecture thus remains open for other input sources of the network definition.

FIGS. 7A, 7B show flow charts of the scheduling algorithm according to the invention. FIG. 7A is a flow chart for a sequential graph. FIG. 7B is a more complex graph using a depth first search (DFS) algorithm.

The following features are accounted for in the algorithm:
1) Scheduling a network of activities including time units and delegation of single dates, activities or sub-networks. The network propagation is done by a commonly known graph algorithm, the DES algorithm.
2) Optionally take a list of additional entry point dates into account with each having a specific priority. CPS will first perform a scheduling by using the entry point with highest priority and than checks, whether the result is consistent with the value of the nominal entry point. If this is the case, the result of the first scheduling will be taken as the overall result. If this is not the case, all other entry points are used for subsequent scheduling calculations. After each individual scheduling the check is re-evaluated. This feature of additional entry points can be used for emulating roundtrips in the scheduling requests. This is needed because in general, a forward scheduling along a sequence of activities followed by a backward scheduling along the same sequence of activities does not result in the original starting time stamp. In general, scheduling is not ‘reversible’.
3) Optionally take constraint on earliest date into account. The constraint may be specified individually for each date type or globally for the complete process.
4) Use optionally push or pull optimization. In case an optimization is used, at the very end of the scheduling the network algorithm will finally starts again at the activity date given in the optimization request and propagates once more towards the future or past time direction in case of push or pull optimization respectively. This kind of optimization is very useful for specific processes. For example, in case of forward scheduling of an outbound process (like a outbound delivery for a sales order) a pull optimization with the delivery date will ensure that there do not occur unwanted time gaps between the activities of the process. These time gaps would lead to an increased overall lead time of the process and, as a consequence, to material requirement dates earlier than needed for the fulfillment of the scheduled delivery date.
5) Take date fixing into account. This allows for date enrichment of a given process by means of CPS, where some of the process dates may already be known and fixed.
6) Define a maximum number of single activity scheduling calculations depending on the given scheduling request, i.e. depending on optimization and fixation requests. Monitor the number of single activity scheduling calculations in order to recognize un-resolvable scheduling requests.
7) The resulting dates are rounded according to their given time unit in the time zone of the activity. The resulting dates are thus time slices with an inclusive start and an exclusive end time stamp. (It is to be noted that a time stamp describes a point in time with the precision of a second.

External processing may be used to:

a) Determine both start and end dates of the activity (2^{nd} grade processing), or
b) Determine the start date of the activity (1^{st} grade processing), or
c) Determine the end date of activity (1^{st} grade processing).

During the pre-step of the CPS, each ABAP-OO class to be used for external processing (according to the evaluation of the dynamic scheme) is asked to determine the details for external processing. This allows the external class to specify at most one out of the three possibilities a), b) and c). This information is stored in the graph objects of configurable process scheduling (ABAP Class /SCMB/CL_SC_GRAPH) and is thus transferred to the scheduling calculator. Therefore the calculator has the information as to whether 1^{st} grade or 2^{nd} grade external processing will be applied.

The total runtime of CPS per individual scheduling request was measured to be in the order of 10 Milliseconds with an SAP APO4.0 system. Naturally, the runtime depends on the methods used within the scheduling framework, namely the methods used for example for master data determination in order to determine activity durations, time zones and calendars.

In the use case example of SAP distribution replenishment planning (DRP), which will use CPS with a simple business process of three sequential activities goods issue, transport and goods receipt, a runtime of 5-8 Milliseconds was measured per scheduling request within a mass planning transaction. The DRP application submits the calendar, time zone and time duration of each activity of the process via the scheduling interface. Thus within the CPS framework no complex methods for master data determination are needed.

FIG. 8A shows the user interface for the definition of the elements of schemes.

FIGS. 8B, 8C show the definition of the logical classes which can subsequently be used within the definition of a scheduling schema. The definition of a logical class includes the definition of the possible usages of the class.

FIGS. 8D, 8E show the UI for the definition of scheduling schemes.

FIG. 9 shows the definition of the business process, which is used by ICH and DRP for scheduling a process consisting of goods issue, transportation and goods receipt. This workflow definition is shipped by SAP within the CPS package.

FIG. 10 shows the assignment of time durations to specific activities. Calendars (working hours) and time zones can be assigned analogous. This data is used within CPS in case specific settings within the scheduling scheme are used which ensure that certain ABAP-OO implementation classes, which read these data, are used for the determination of the duration of the activity.

FIG. 11 shows the overview of the complete customizing of the configurable process scheduling.

The configurable process scheduling comprises a test tool (see last point in the customizing view above), which enables to perform a stand-alone scheduling outside of other applications and which results in an explanation UI that provides several views. The views according to FIGS. 12A, 12B provide the scheduling result as well as information on the insights of the scheduling.

SCM scheduling is able to schedule a network of activities. The definition of this network consists of a description of a single activity and a description of the network.

A single activity consists of the following:
Activity type
Date type of the start of the activity
Date type of the end of the activity
Duration type of the activity
Calendar of the activity
Time zone of the activity
Time unit of the start date, time unit of the duration and time unit of the end date

An activity network consists of:
Nodes (equivalent to a scheduling activity)
Lines (link predecessor and successor nodes)

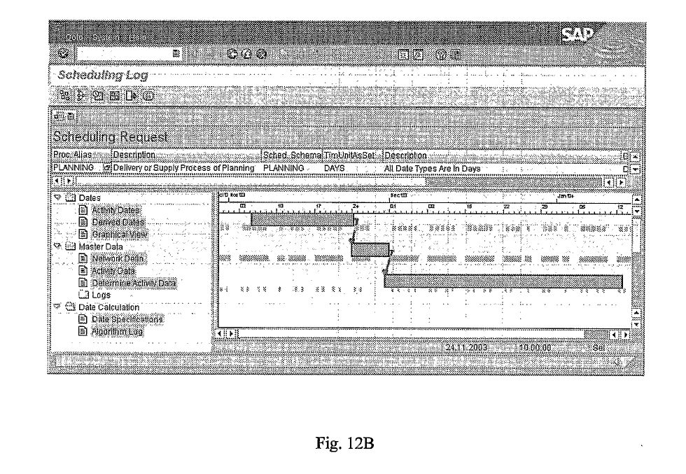

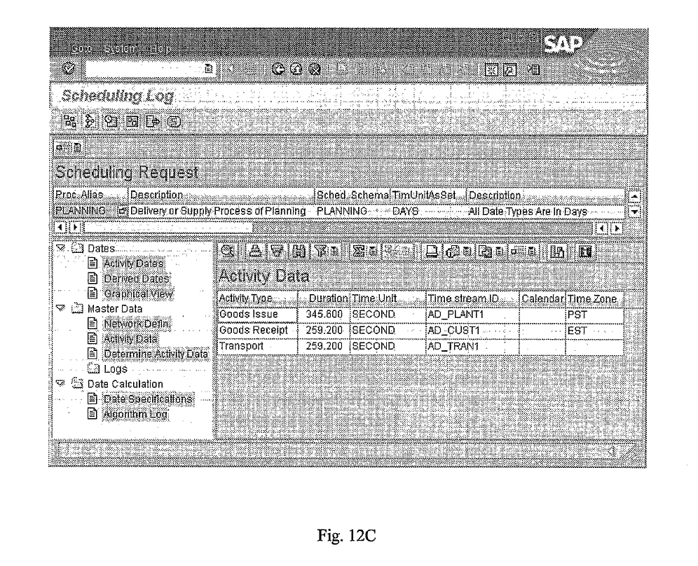

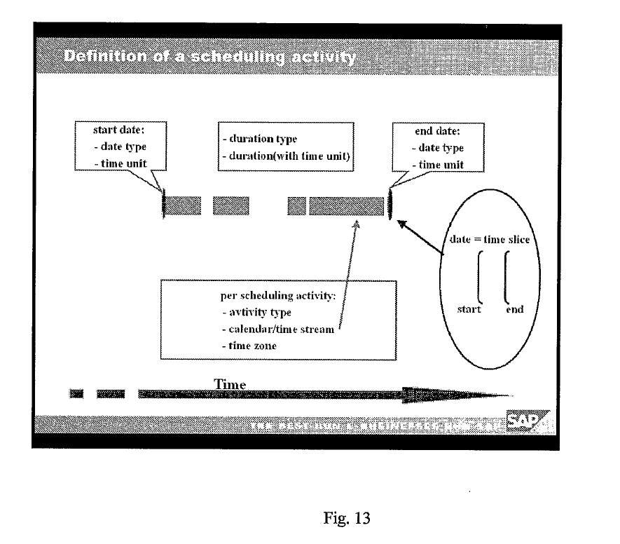

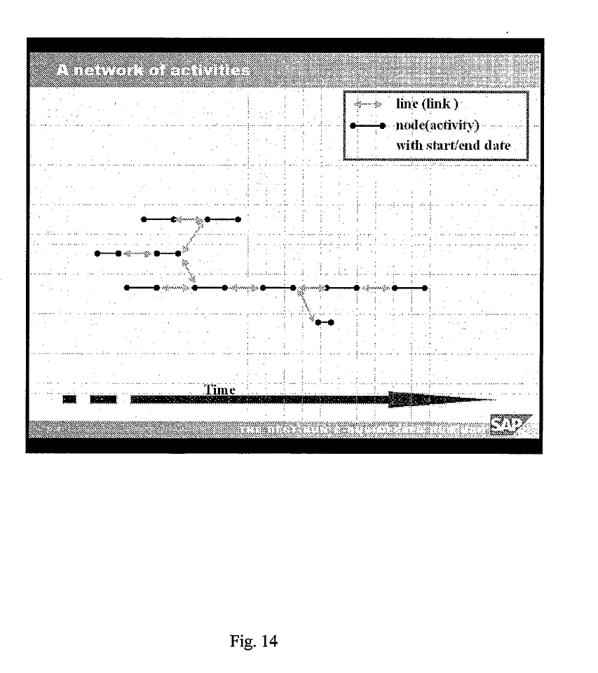

FIGS. 13 and 14 show the description of a scheduling activity and an activity network.

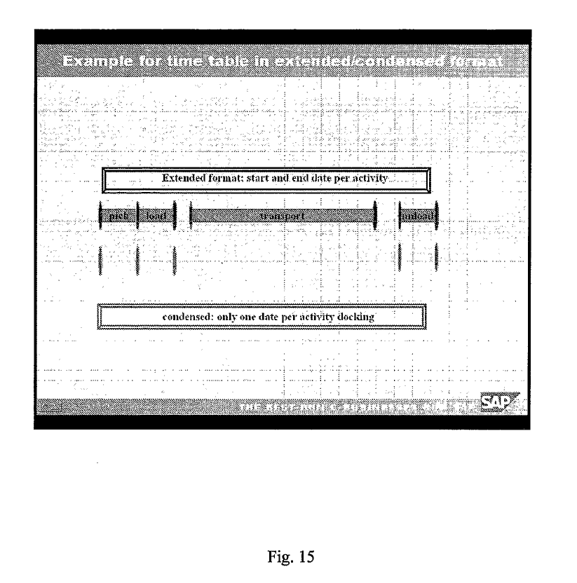

SCM scheduling can describe a network of activities in time by means of two different timetable formats. The extended timetable format consists of two dates for each activity (start and end-date of the activity). The condensed timetable format consists of a list of dates that can be derived from the extended timetable. FIG. 15 shows an example of a simple activity graph with an extended and a condensed timetable.

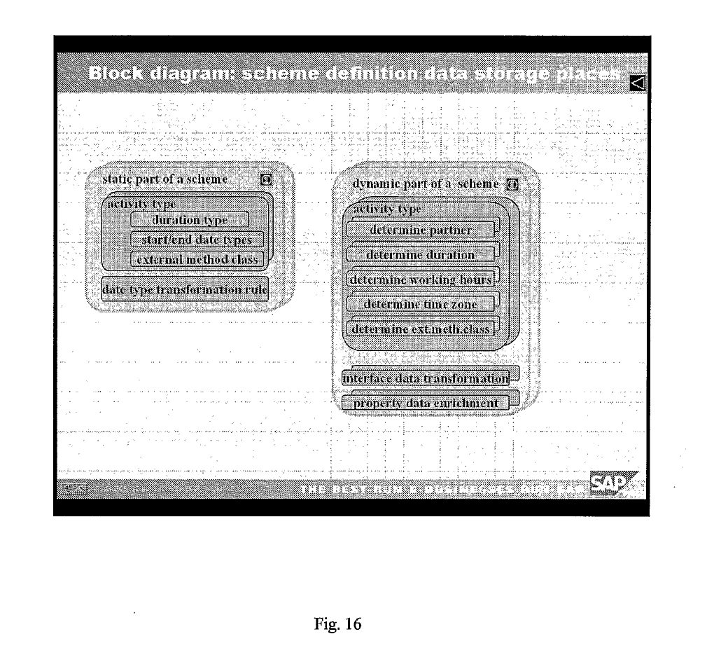

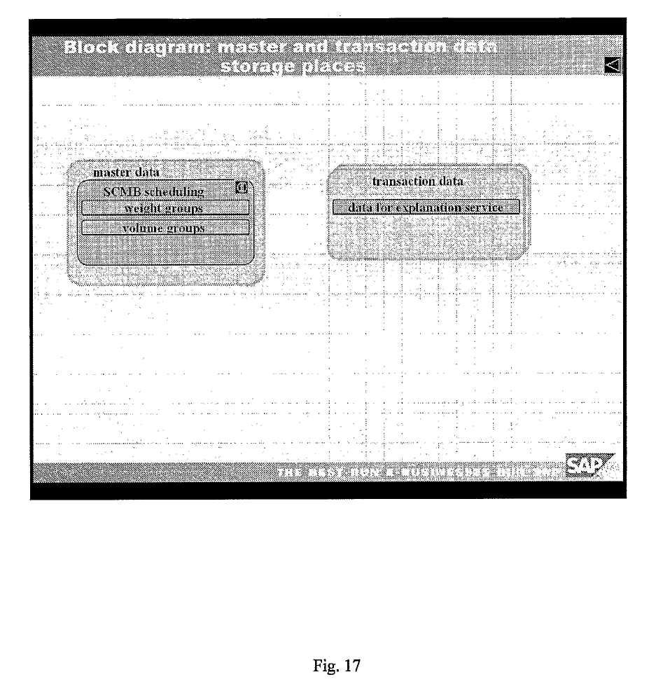

FIGS. 16, 17 show in a block diagram an overview of the data storage places of the scheduling.

SCM scheduling comprises services for the following:
Scheduling a business process
Presenting and explaining the scheduling result
Posting SCM scheduling transaction data and external processing

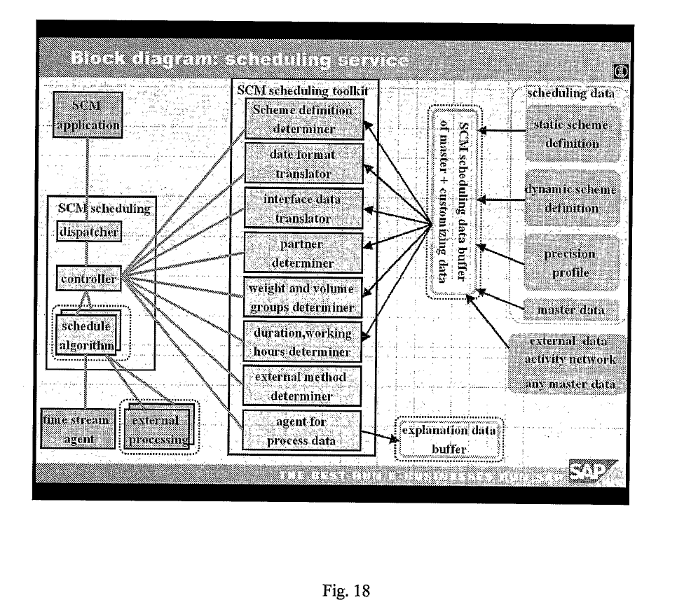

FIG. 18 shows, in a block diagram, an overview of the active components of the scheduling when the scheduling service is processed:

An external application calls the scheduling service via its API. The SCM scheduling first routes all methods of the API through an entry agent which then carries out a functional dispatch. This entry agent provides a single point of entry to the SCM scheduling framework internally although the framework provides several API methods.

If scheduling is requested, the entry agent will dispatch to the scheduling controller. The controller first performs a pre-step that makes use of the scheduling toolkit in order to derive the static scheme and the dynamic scheme. This results in a description of the complete graph of activities that includes information from the scheme, the activity network and the master data. This graph of activities description holds all information necessary for a subsequent scheduling engine. The controller then invokes the scheduling engine.

The scheduling engine performs the pure scheduling algorithm for a network of activities.

Scheduling of individual activities is done by the activity objects that are instances of an ABAP-OO class. Activity objects are contained in the description of the graph of activities built by the controller. They make use of an interface of a time stream agent that is able to carry out basic scheduling functions by means of SAP Basis package SZTI. Package SZTI provides the function needed to calculate with different time units taking time zones, factory calendars and time streams into consideration. Activity objects also make use of an interface for external processing, which might have to be called for certain activities in order to set start- or end-date of the activity, or in order to schedule the complete activity using an external method.

After the scheduling engine has completed its work, the controller stores the result and additional explanation data in the explanation data buffer.

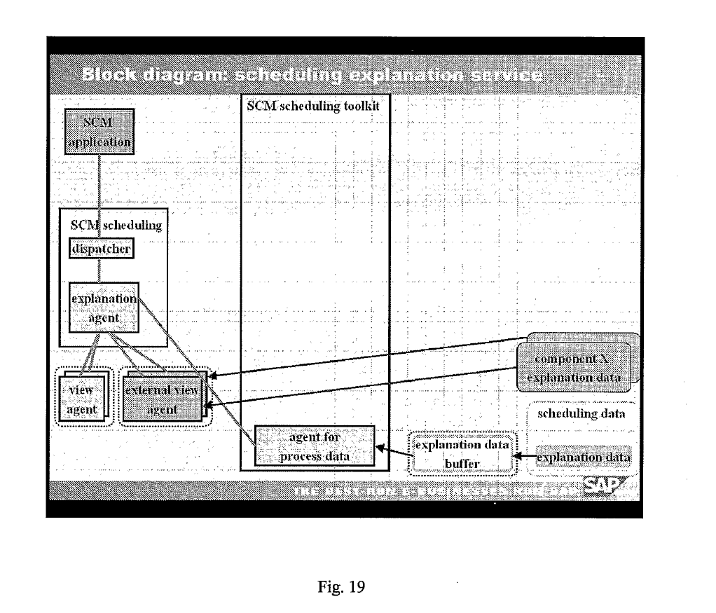

FIG. 19 shows, in a block diagram, an overview of active components of the scheduling when the explanation service is processed.

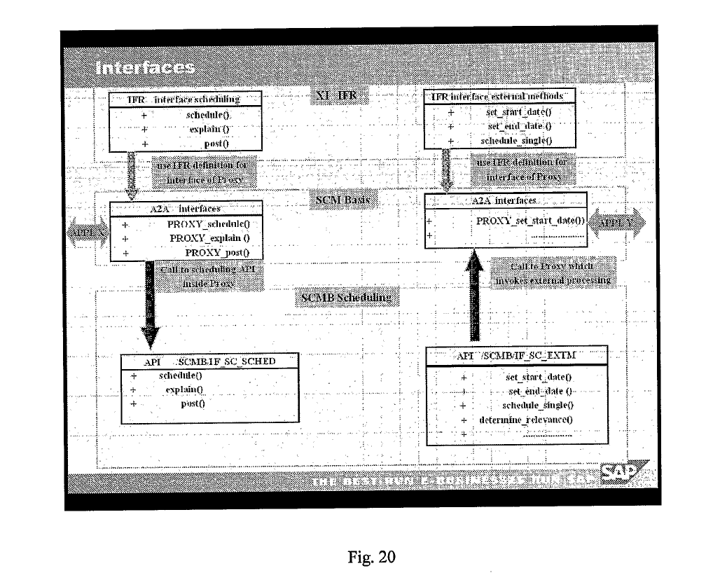

FIG. 20 displays interfaces used in the present invention.

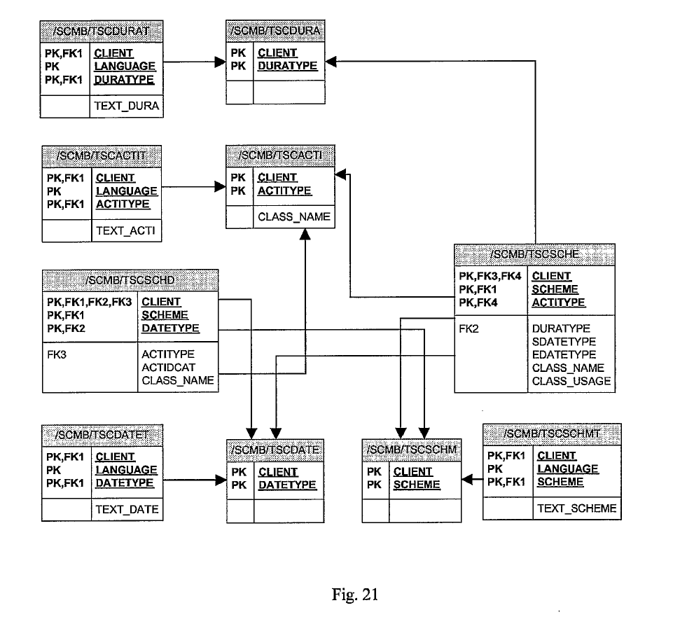

FIGS. 21-26 display data structures used in the present invention.

SCM scheduling uses a DFS algorithm because it is important to at first perform backward scheduling to the very first date present in the network. This arises from the possibility to constrain the earliest allowed date and from the possibility that in backward scheduling, an activity can be shifted towards the future due to the results of external processing. For example, an ATP check on the start of picking might postpone the activity to a later date during backward scheduling also. If one of these actions takes place, the complete result of the backward scheduling performed so far becomes invalid and the scheduling has to be restarted with a new entry point. If a backward scheduling (starting from the entry date) is performed using the DFS algorithm, the number of restarts of the scheduling is minimized.

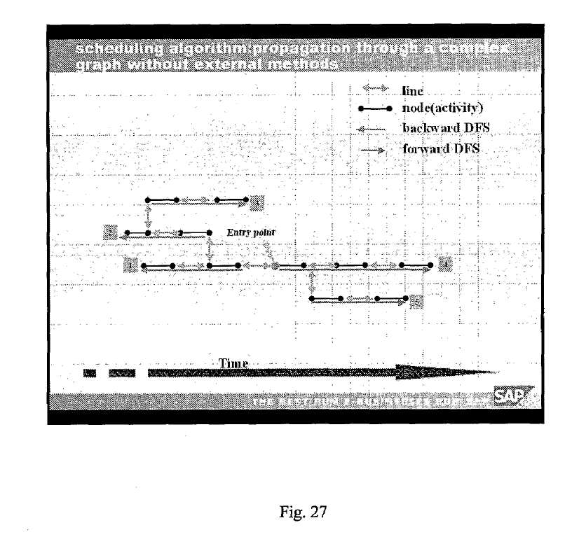

The BPM data denotes the time relation of the activities by defining a line by a pair of (predecessor node, successor node, (n, n′)). SCM scheduling will perform a DFS by first carrying out a backward depth first search with a subsequent forward depth first search. In the backward depth first search, all nodes (activities) that can be accessed by starting with a backward (in time) arrow from the entry node will be visited. Backward depth first search scheduling may also comprise paths that include propagation forward in time, see DFS tree path number 3 in FIG. 27.

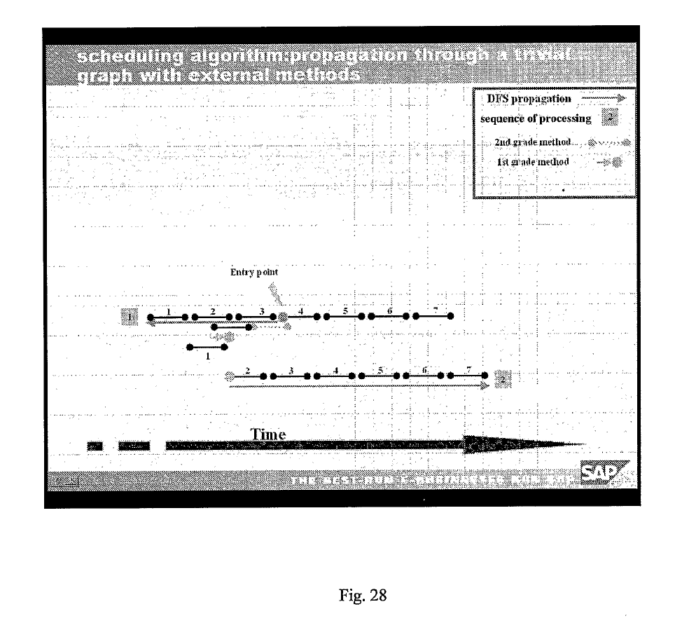

FIG. 28 shows how a simple graph of two branches is scheduled with external processing. First a backward DFS is carried out. Within this backward DFS a 1^{st} grade external processing delays the start of the second activity. Due to this delay, the the already scheduled activities 3 and 2 are invalidated and the forward DFS is started with a new entry point (start of activity 2).

SCM scheduling does not support all kinds of graphs.

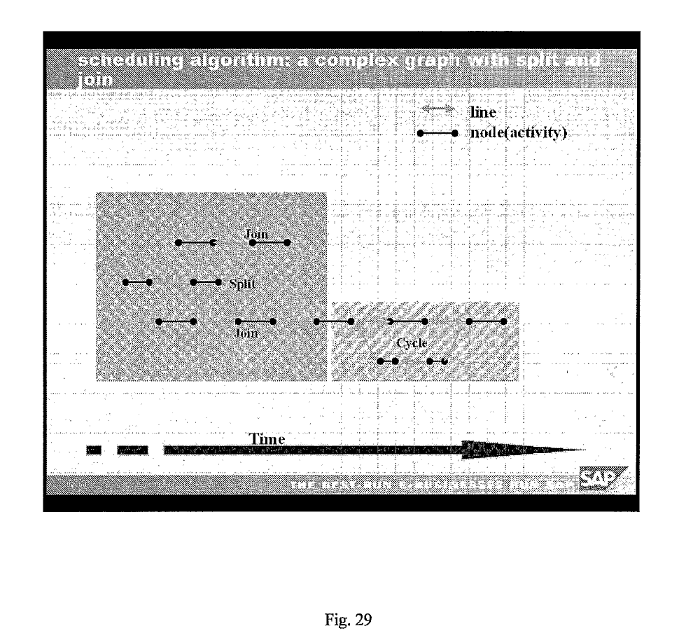

FIG. 29 is an example of a complex graph with allowed split/join and a non-allowed section on the right.

The following is a sketch of the basic algorithm:

```
1) Definitions:
B is the array of nodes that were visited during depth first search
R is the array of nodes that have arrows that are still unprocessed
N is a node
PN is an array that comprises all unprocessed arrows of the adjacent list
of N
Interface of procedure ‘propagate’:
Entry point node b, PN for all N (list of adjacent arrows of N)
Coding of procedure ‘propagate’:
  Initialize B and R (reset)
  Add b to B
  Add b to R
  WHILE (R is not empty)
  Select node N out of R
  IF PN is empty
    Delete N from R
  ELSE
    N′ = PN (first element).end (propagate next arrow of list of
unprocessed adjacent arrows)
    delete PN (first element) (mark arrow as used!)
    IF N′ is not element of B
      Add N′ to B (mark N′ as visited node)
      Add N′ to R (include N′ into the array of nodes
that might have
                              unprocessed arrows)
    ENDIF
  ENDIF
  ENDWHILE
```

For a depth first search: ‘Select node out of R’ has to be implemented as last in first out (LIFO). For breadth first search: ‘Select node out of R’ has to be implemented as first in first out (FIFO). The LIFO implementation can be carried out using an internal table for R. Adding an element to R can be carried out by an insert table index 1, the “Select node out of R’ can then be carried out by a read index 1.

In order to separate into backward and forward DFS scheduling, the procedure ‘propagate’ has to be processed twice. For backward DFS the list of unprocessed adjacent arrows of the entry point node (activity) will only comprise the backward links. For forward DFS the list will only comprise the forward links. A backward link of node N is a line with node N as successor node.

In addition to the general split into backward/forward DFS propagation, all lists of adjacent arrows PN(n) will be sorted in such a way that the backward links are first. The above algorithm that selects the next node by looking at the first item of the list of unprocessed arrows with code N′=PN (first element).end will first execute the DFS paths directing into the past. This is shown in the above figure of propagation via a complex graph where path 2 is propagated before path 3.

The scheduling of individual activities will be done when the node (activity) is marked as visited in the above-described DFS algorithm.

The DFS algorithm is only a part of the complete scheduling algorithm, because in addition to propagating via a graph the scheduling has to fulfil several features.

Here is the rough flow control of the complete algorithm.

While (no valid results and convergence strategy not yet done)
Loop on entry points (last one is the nominal entry point)
   Backward DFS propagation from entry point.
   If during backward propagation in time a delay occurred due to external processing (such as an ATP check), the delayed activity that was calculated at last will be the entry point of a subsequent forward DFS propagation. A complete path (branch) will be processed to its end before switching to the forward DFS.
   If during backward propagation in time a fixed date cannot be met by the scheduling, this will be analogous to delays due to external processing. If the fixed date is earlier than the scheduled date, no special handling will be carried out. In the case of backward processing in time, the earlier date will be taken. In case of forward processing in time, an early fixed date that cannot be met will cause a backward DFS propagation starting at the fixed date.
   Forward DFS propagation from entry point or an activity that was delayed due to external processing in the backward DFS. Forward DFS may include a scheduling backward in time. If during this backward scheduling a delay occurs (due to external processing) this will create the need for a forward DFS starting with this delayed activity.
   Push/pull optimization: Redo scheduling starting from the date that should be fixed in the optimization. Pull/push will start backwards/forward DFS in one direction only (starting from the date that is specified in the optimization request).
   Check whether this optimization date is unchanged in the new result. If it has changed, the result obtained before optimization is taken. Optimization failure can occur due to activity delays created in external processing.
   Check on earliest allowed date. If needed, redo complete scheduling with a forward DFS starting at the earliest node (start date of an activity) as calculated in the previously preformed scheduling.
   Check whether the request is met by the processing of this entry point. (->valid result)
   If the nominal entry point has been processed (and no error due to convergence has occurred), this is always a valid result
   End loop on entry points
Exception handler for endless propagation: Ensure consistent result data and/or invoke convergence improvement
ENDWHILE (no valid result, and convergence strategy not yet done)

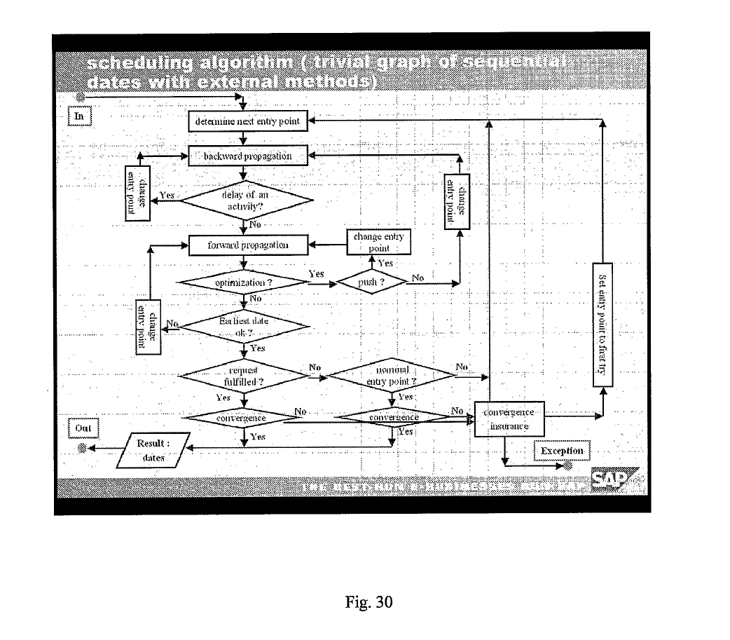

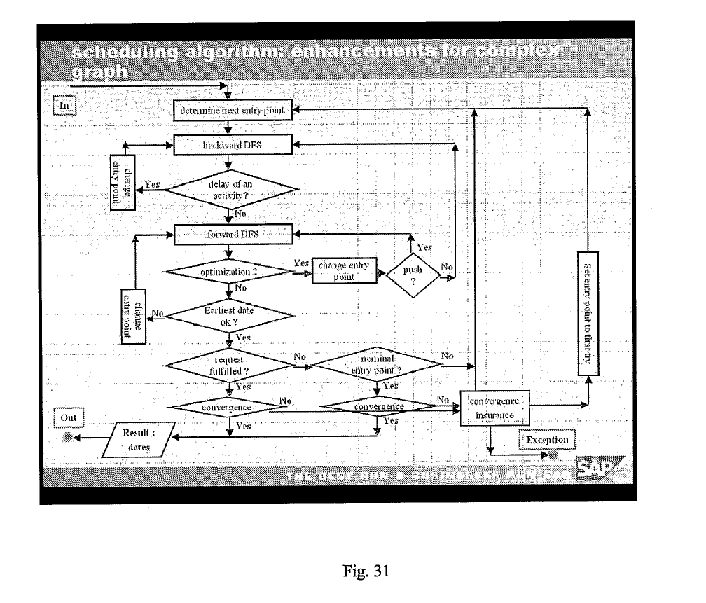

FIGS. 30, 31 show the flow control of the algorithm. Backward propagation denotes backward scheduling in a simple linear graph. A more complex graph can be scheduled using the same algorithm with the DFS algorithm.

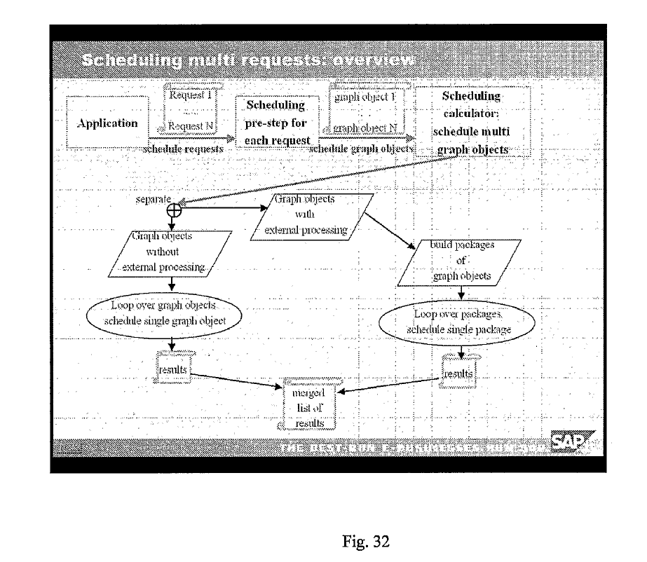

FIG. 32 gives an overview of the scheduling of multi requests.

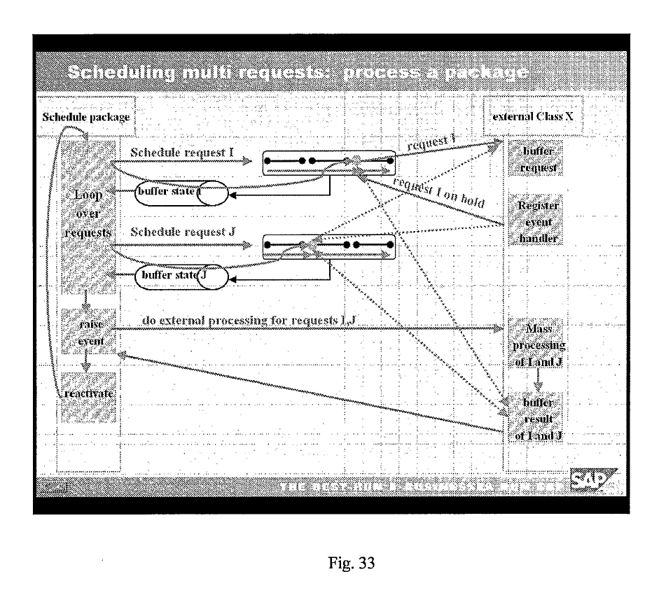

FIG. 33 shows the concept for accumulating individual requests of external processing.

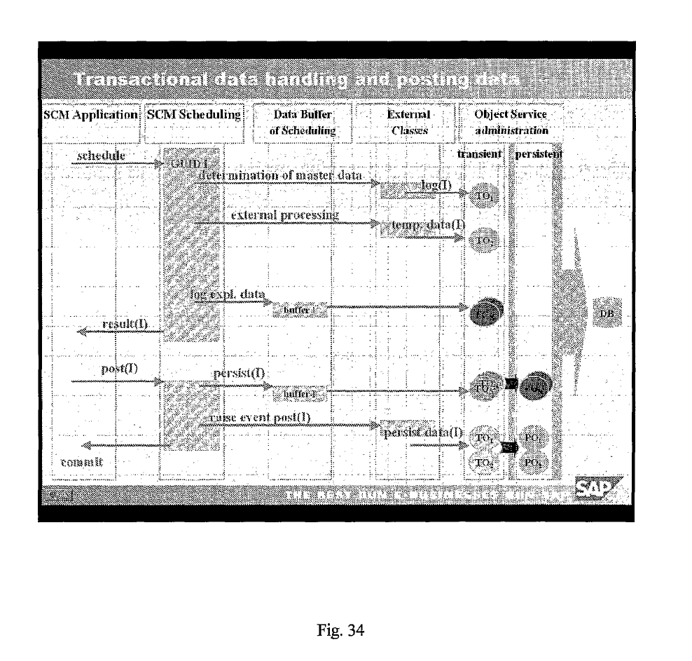

FIG. 34 outlines management of transactional data and posting of data.

In the following, some definitions are given.

### Step of a Business Process:

Part of a business process that can be considered independently in the description of a business process. A business process can be described by a set of steps and the relations of these steps.

### Scheduling Activity:

Step of a business process that should be taken into account by scheduling because this process step needs a period of time (duration) for processing. This processing duration can either be of technical type (for example period of time needed for certain IT actions) or of business type (for example period of time needed for picking of goods in a warehouse). Note that in this document the word ‘activity’ always implies relevance for scheduling, otherwise the word ‘step’ is used.

### Scheduling Activity Network:

Description of the relative arrangement of business process activities with regard to time. This also defines the scheduling activities that are present in the business process.

### Date Type:

Technical name with a (multilingual) text that describes the business content of a date, for example technical name ‘LDDAT’ with description ‘start of loading at shipping plant’. Each activity has two date types that describe the start date and the finish date of the activity.

### Date:

Consists of a date type and a value. The value can be either a time stamp or a time slice, depending on the precision of the date. The technical name of the date type identifies the date technically.

### Scheduling Timetable:

Set of dates that describes the business process with regard to time. The result of a scheduling service call is a scheduling timetable. Configurable Process Scheduling (CPS) may work with two different formats of timetable, the complete and the derived timetable (see below).

### Complete Timetable:

Contains a start date and a finish date for each activity of a scheduling activity network. Each date type can only be used once in the complete timetable.

### Derived Timetable:

A list of dates that can be derived from the complete timetable. For example, the derived timetable may be a subset of the dates of the complete timetable. A date from the derived timetable can be transferred to a date of the complete timetable. Dates that can be transferred from the complete timetable to the derived timetable and vice versa do not necessarily need to have the same date type. In this way the description of the business process dates can be different in the complete and derived timetable.

### Scheduling Schema:

A set of meta data that describes a framework used for the technical processing of scheduling. It defines how individual activities of business processes are to be handled within scheduling. A scheduling schema contains a list of those activities for which the framework is defined. A scheduling schema can be used by several different business processes (described by a scheduling activity network). The schema has to contain all scheduling activities of the process. The schema may contain more scheduling activities than the scheduling activity network. The scheduling schema consists of a static part and a dynamic part.

### Activity Type:

Technical name with a (multilingual) text that describes the business content of an activity (from the point of view of scheduling). Each activity of a process has such an activity type. An activity type has to be unique within a single process. Thus the activity type identifies one step of a business process. For example an activity type may be ‘LOADATPLANT’ with the description text ‘load at shipping plant’.

### Activity Type Category:

Technical name with a (multilingual) text that describes the business content of an activity. Each activity of a process has an activity type category. The difference between activity type category and activity type is that an activity type category within a business process does not need to be unique. The activity type category describes the business content of an activity less precisely than the activity type. Thus, several activities that can have a very similar content (such as ‘load at shipping plant’ and ‘load at transshipment point’) can be treated in a similar way by scheduling. For example, the time needed to process the activity can be determined solely using the activity type category. (In the above example, this would mean that the duration of loading is independent of the location shipping plant/transshipment point).

### Delegation:

Delegation denotes that an activity is (partially) scheduled by means of an ABAP-OO class that does not belong to the core framework of Configurable Process Scheduling. These classes may belong to any software package that includes any other component/application.

### Partial Delegation:

Only one date (start or finish date) of the activity is determined.

### Complete Delegation:

Start and finish date of the activity are scheduled.

### Coherent Complete Delegation:

A set of directly linked activities (a scheduling activity network) is scheduled together by a single call to a method of an ABAP-OO class. A complete scheduling result is thus obtained for all activities. The network of activities that is coherently processed can be a sub-network of the scheduling activity network or the complete scheduling activity network.

### Time Unit:

is needed to define dates and durations. Each duration needs a number and a time unit. A time unit is optional to describe a date with a certain precision. For example a date with the unit ‘day’ will not be precise at ‘seconds’ level, it will be rounded to a precision of a day. A date without a time unit is a simple time stamp with a precision of a second. This is also called time unit ‘exact’. A date with a time unit is a time slice with a start and end time stamp.

### Time Unit Assignments:

Defines for a set of date types a time unit that will be used in the scheduling algorithm. Time unit assignment can be re-used in several different business processes. Date types that are used in the business process but that have no time unit assigned are treated as dates with time unit ‘exact’. This means that they are simple time stamps only.

### Scheduling Calendar:

An SAP factory calendar or an SAP time stream.

### Entry Point Date:

The date that is passed to CPS as the starting point for the scheduling algorithm. The date has to exist in the timetable (complete or derived) of the activity network. CPS may change this date; it is not fixed in the scheduling algorithm.

### Alias of a Business Process:

Refers to an existing workflow definition via a mapping table. The scheduling can thus be called using an alias of a business process instead of a workflow ID.

1. Method of configuring a business process for scheduling,
the business process comprising a plurality of activities, each activity comprising at least one of a start date type and a stop date type; the activities being in a time relationship to each other; wherein
the business process is freely configurable with respect to the plurality of activities and with respect to the time relationships of the activities to each other.

2. The method according to one of the preceding claims, wherein a technical ID is associated with an activity or with a date type.

3. The method according to one of the preceding claims, wherein a text is associated with an activity or with a date type, the text being descriptive for the activity or for the date type.

4. The method according to one of the preceding claims, wherein time units are assigned to specific date types, the time units being freely configurable for each date type.

5. The method according to one of the preceding claims, wherein an activity can be modeled as a plurality of sub-processes.

6. The method according to one of the preceding claims, wherein a sub-process comprise a plurality of activities.

7. The method according to one of the preceding claims, wherein a decision whether or not a delegation is invoked is during run-time of the scheduling.

8. The method according to one of the preceding claims, wherein said service functions being usable for determination of time zone, calendar and duration of an activity.

9. The method according to one of the preceding claims, wherein at least one service function is assigned to at least one activity, the service function being usable, during scheduling, for determining start date and/or finish date of the at least one activity.

10. The method according to one of the preceding claims, wherein at least one delegation scheme is assigned to at least one activity, the delegation the service function being usable for invoking, during scheduling, an external application for determining start date and/or finish date of the at least one activity.

11. The method according to one of the preceding claims, wherein the activities and their time relationship are representable as a network of nodes and edges, each node representing one of the plurality of activities, and each edge connecting a pair of nodes and representing a predecessor-successor relationship of the activities represented by the respective pair of nodes.

12. The method according to one of the preceding claims, wherein a scheduling scheme is produced based on the configured business process, whereby the scheduling scheme is a set of meta data descriptive of how the individual activities are to be processed within scheduling.

13. The method according to claim 1, wherein a scheduling scheme is associated to the business process, the scheduling scheme comprising configuration data to at least one of duration, calendar, and time zone.

14. The method according to one of the preceding claims, wherein a scheduling scheme is associated to the business process, the scheduling scheme comprising configuration data to at least one of service function, and delegation process model.

15. A method of scheduling a business process, whereby the business process is configured with the method preferably according to claim 1.

16. Method of configuring a production process for simulating,
the production process comprising a plurality of steps, each step comprising at least one of a start date type and a stop date type; the steps being in a time relationship to each other; wherein
the production process is freely configurable with respect to the plurality of steps and with respect to the time relationships of the steps to each other.

17. A computer system for performing the method according to one of the preceding claims.

18. A computer-readable storage medium comprising program code for performing the method according to one of claims 1 to 16, when loaded into a computer system.
